(19) United States
(12) Patent Application Publication
(10) Pub. No.: US 2007/0259260 A1
(43) Pub. Date: Nov. 8, 2007

(54) Electrochemical lead-acid rechargeable battery

(75) Inventor: Sandra Johns, Sarstedt (DE)

Correspondence Address: FOLEY & LARDNER LLP, 777 EAST WISCONSIN AVENUE, MILWAUKEE, WI, 53202-5306, US

(73) Assignee: VB Autobatterie GmbH & Co., KGaA

(21) Appl. No.: 11/229,334

(22) Filed: Sep. 16, 2005

(30) Foreign Application Priority Data
Sep. 17, 2004 (DE) 102004045095.1-45

(51) Int. Cl. H01M 2/14

(52) U.S. Cl. 429/143

(57) ABSTRACT

An electrochemical lead-acid rechargeable battery includes a plurality of alternately arranged anode and cathode plates having separators therebetween, the separators each having a microporous separator layer composed of polyethylene and a fibre layer on each surface of the separator layer. The battery also includes an electrolyte surrounding the anode and cathode plates as well as the separators. The microporous separator layer and the fibre layer each have a thickness of at least 100 μm. The average fibre length of the fibre layer is more than 1 mm and the average fibre diameter of the fibre layer is more than 1 μm, and the fibre layers are firmly connected to edge areas of the associated separator layer.

### CROSS-REFERENCE TO RELATED PATENT APPLICATIONS

This application claims the benefit of German Application No. DE 10 2004 045 095.1-45, filed Sep. 17, 2004. The disclosure of German Application No. DE 10 2004 045 095.1-45, including the specification, drawings, claims and abstract, is incorporated herein by reference in its entirety.

### BACKGROUND

The present invention relates to electrochemical lead-acid rechargeable batteries. Such batteries may include a large number of alternately arranged anode and cathode plates, which contain lead, having separators in each case between adjacent anode and cathode plates and having an electrolyte which surrounds the anode and cathode plates as well as the separators, with the separators each having a microporous separator layer composed of polyethylene, and having a fibre layer on each surface of the separator layer.

An electrochemical lead-acid rechargeable battery with porous separators between the electrode plates is described in U.S. Pat. No. 5,962,161. The separators are formed from extremely fine fibre material with a diameter of less than 5 μm. The separator layer, which contains fibres, is treated with a solvent, in order that it can be impregnated with acid, and in order to absorb the liquid acid completely.

Furthermore, an electrochemical lead-acid rechargeable battery with separators between the electrode plates is described in British Patent No. GB 1,056,273, which electrode plates have a layer composed of kieselguhr which is arranged between two non-woven layers composed of acid-resistant thermoplastic resin. The non-woven layers can be connected to one another at the edges, and form pockets in which the kieselguhr layer is held. The microporous kieselguhr layer is relatively thick, at about 500 μm, and together with the non-woven layer leads to relatively major immobilization of the electrolyte, owing to the capillary suction capability.

Furthermore, an electrochemical lead-acid rechargeable battery with a fibre layer is described in U.S. Pat. No. 6,689,509 B2, which fibre layer is enclosed by two microporous polyethylene membranes and is connected to them, for example, by adhesive bonding, ultrasound welding or sewing.

DE 19 49 958 C3 discloses a separator for maintenance-free rechargeable batteries, in which ultrafine fibre mats with a fibre diameter of less than 1 μm are used. The layers that are used have a porosity of 70 to 95%. For greater layer thicknesses, it is proposed that microporous material and ultrafine fibre mats follow one another alternately in such a way that the outer layers, which are in contact with the electrodes, are always composed of ultrafine fibre mats.

A separator with a microporous polyolefin membrane and a non-woven layer on at least one surface of the microporous membrane for a lithium-ion wound battery is described in EP 0 811 479 B1. The membrane has a thickness of 25 to 200 μm, and the non-woven layers have a thickness of 30 to 500 μm. The fibres in the non-woven layer have a diameter of 0.1 to 500 μm.

A separator with an elastic fibre mat having at least two layers and composed of randomly aligned, felted glass microfibres, is described in WO 98/12759 A1. The electrolyte is immobilized to a relatively major extent by the fine fibre layers, which are felted with one another.

In comparison to wet lead-acid batteries, the immobilization of the electrolyte, in particular in AGM batteries, has the following disadvantages:
(a) poor price to performance ratio;
(b) relatively long formation duration/poorer forming capability;
(c) poor mass utilization, poorer power capability;
(d) in addition, expensive components, such as glass non-woven and valve plugs;
(e) expensive material for the battery box, for example because of the higher mechanical strength and talcum-filled polypropylene PP;
(f) thick-walled, heavy battery boxes;
(g) increased assembly effort (increased unit pressure at the same time);
(h) specific positive and negative masses;
(i) specific filling devices for the sulphuric acid; and
(j) increased test effort.

The problem of the known separators is that, because of the fine and/or thick non-woven layers, the electrolyte is relatively strongly solidified, since the acid is held by capillary action. It would be desirable to provide an improved separator that includes various advantages as may be described below we well as other advantages that will be apparent to those reviewing this disclosure.

### SUMMARY

An exemplary embodiment of the invention relates to an electrochemical lead-acid rechargeable battery that includes a plurality of alternately arranged anode and cathode plates having separators therebetween, the separators each having a microporous separator layer composed of polyethylene and a fibre layer on each surface of the separator layer. The battery also includes an electrolyte surrounding the anode and cathode plates as well as the separators. The microporous separator layer and the fibre layer each have a thickness of at least 100 μm. The average fibre length of the fibre layer is more than 1 mm and the average fibre diameter of the fibre layer is more than 1 μm, and the fibre layers are firmly connected to edge areas of the associated separator layer.

### BRIEF DESCRIPTION OF THE DRAWINGS

The invention will be explained in more detail in the following text with reference to the attached drawing, in which:

FIG. 1 shows a plan view of a detail of an electrochemical lead-acid rechargeable battery with alternately arranged anode and cathode plates and with separators between them.

### DETAILED DESCRIPTION OF EXEMPLARY EMBODIMENTS

According to an exemplary embodiment, an improved electrochemical lead-acid rechargeable battery is provided in which the adhesion of the electrolyte in the separators between the electrode plates is reduced. It is intended that such lead-acid rechargeable batteries may be capable of being produced at relatively low cost.

According to such an exemplary embodiment, such an electrochemical lead-acid rechargeable battery of this generic type includes the following characteristics:
(a) the microporous separator layers and the fibre layers each have a thickness of at least 100 μm;
(b) the average fibre length of the fibre layers is more than 1 mm, and the average fibre diameter of the fibre layers is more than 1 μm; and
(c) the fibre layers are firmly connected to the associated separator layer in the edge areas.

In contrast to conventional separators with fibre layers which cover a microporous separator layer, it is proposed that the fibre layers have a relatively long fibre length and a relatively large fibre diameter, and that the microporous separator layer be relatively thick. The use, which is known per se, of a microporous separator layer composed of polyethylene allows the fibre layers to be firmly connected to the associated separator layer, for example by ultrasound welding, thermal welding or adhesive bonding, in the edge areas.

The relatively long fibre length and the relatively large fibre diameter mean that the electrolyte is not held by capillary action, and that different electrolyte adhesions occur in the three layers, specifically the fibre layers and the separator layer. For this purpose, the suction capability of the fibre layers is increased by the choice of the relatively long fibre length and large fibre diameter.

In this case, it has been found that three-layer separators in which a non-woven is introduced between two microporous layers, cannot be used for starter batteries. In fact, the mass should be held by the outer non-wovens. This functionality is not achieved by porous layers. Furthermore, when a non-woven is located between porous layers, the internal resistance was greatly increased, and proton and sulphation exchange are not possible. The current draw from the battery would thus be decreased.

The separator layers may also have a large number of ribs on at least one surface, so that the three-layer separator still forms a sufficiently planar surface which can rest against the electrode plates over a large area.

In a manner known per se, the fibre layers may be a polyester non-woven and, in particular, a polyolefin fibre non-woven. In conjunction with the microporous polyethylene separator layer, the fibre layers can then be ultrasound-welded to the separator layer on the edge areas. This ensures that the fibre layer is connected to the separator layer permanently and at low cost.

The fibre layers preferably have a thickness of up to 600 μm, and the separator layers have a thickness of up to 400 μm. The separators are thus relatively thick, at about 300 μm to 1600 μm.

The porosity of the separator layers is preferably in the order of magnitude of 50 to 70%.

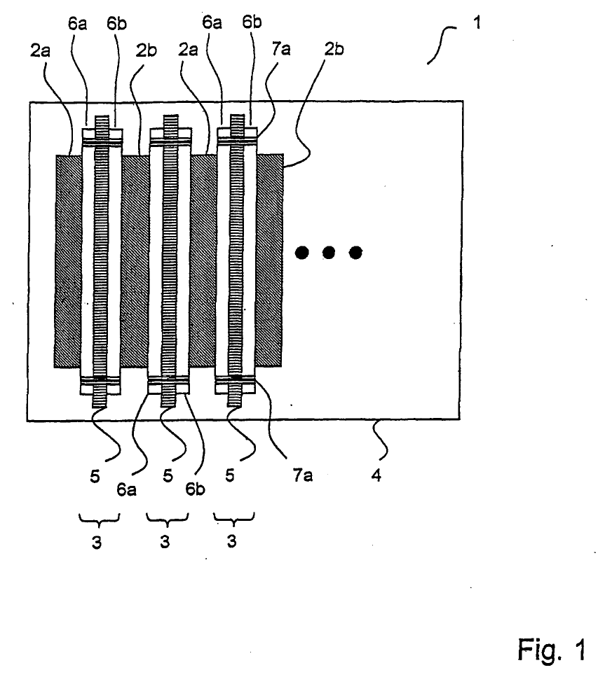

FIG. 1 shows a detail of an electrochemical lead-acid rechargeable battery 1 with a large number of alternately arranged anode and cathode plates 2a, 2b, which contain lead, between which separators 3 are arranged. The anode and cathode plates 2a, 2b with the separators 3 are held in a vessel 4 which is filled with electrolyte.

The separators 3 each comprise a microporous separator layer 5 composed of polyethylene, which is enclosed by a fibre layer 6a, 6b on both sides. The fibre layers 6a, 6b are ultrasound-welded to the associated separator layer 5 by means of an ultrasound bead 7a, 7b in the edge areas. This is possible by virtue of the choice of polyethylene as the separator layer material and polyester, in particular polyolefin, for the fibre layers 6a, 6b in the form of a fibre non-woven, possibly with a glass component.

The fibre layers 6a, 6b may, however, also be thermally connected to the separator layer 5, by sewing, or in some other way.

The separator layers 5 composed of polyethylene may, if required, also contain silicic acid.

The important factor is that the fibre length is more than 1 mm and the fibre thickness of the fibre layers 6a, 6b is more than 1 μm, so that the electrolyte is not held by capillary action. The different electrolyte adhesions which occur in this case in the fibre and separator layers 6, 5 are advantageous. Furthermore, the relatively long fibre length and the relatively large fibre thicknesses reduce the suction capability of the fibre layers 6a, 6b.

The overall thickness of the separator can be varied by variation of the basic thicknesses of the two fibre layers 6a, 6b and of the separator layer 5 in the range from 100 μm to 600 μm for the fibre layers and 100 μm to 400 μm for the separator layers. The important factor in this case is that only one three-layer separator 3 is arranged between two adjacent anode and cathode plates 2a, 2b.

The large number of ribs on the surface of the separator layers 5 allow a certain amount of acid movement between the anode and cathode plates 2a, 2b.

It is important to note that the construction and arrangement of the separator as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. Accordingly, all such modifications are intended to be included within the scope of the present invention as defined in the appended claims. Other substitutions, modifications, changes and omissions may be made in the design, operating conditions and arrangement of the other exemplary embodiments without departing from the scope of the present invention as expressed in the appended claims.

What is claimed is:

1. An electrochemical lead-acid rechargeable battery comprising:
a plurality of alternately arranged anode and cathode plates having separators therebetween, the separators each having a microporous separator layer composed of polyethylene and a fibre layer on each surface of the separator layer; and
an electrolyte surrounding the anode and cathode plates as well as the separators;
wherein the microporous separator layer and the fibre layer each have a thickness of at least 100 μm;
wherein the average fibre length of the fibre layer is more than 1 mm and the average fibre diameter of the fibre layer is more than 1 μm; and
wherein the fibre layers are firmly connected to edge areas of the associated separator layer.

2. The electrochemical lead-acid rechargeable battery of claim 1 wherein the separator layer has a plurality of ribs on at least one surface.

3. The electrochemical lead-acid rechargeable battery of claim 1 wherein the fibre layer is ultrasound-welded, thermally welded, or adhesively bonded to the associated separator layer in the edge areas.

4. The electrochemical lead-acid rechargeable battery of claim 1 wherein the fibre layer is in the form of a polyester non-woven material.

5. The electrochemical lead-acid rechargeable battery of claim 1 wherein the fibre layer is in the form of a polyolefin fibre non-woven material.

6. The electrochemical lead-acid rechargeable battery of claim 1 wherein the fibre layer has a thickness of up to 600 μm.

7. The electrochemical lead-acid rechargeable battery of claim 1 wherein the separator layer has a thickness of up to 400 μm.

8. The electrochemical lead-acid rechargeable battery of claim 1 wherein the porosity of the separator layer is between 5 and 70%.
